(19) United States
(12) Patent Application Publication
(10) Pub. No.: US 2024/0274365 A1
(43) Pub. Date: Aug. 15, 2024

(54) MULTILAYER CERAMIC CAPACITOR

(71) Applicant: SAMSUNG ELECTRO-MECHANICS CO., LTD., Suwon-si (KR)

(72) Inventors: Soo Hwan SON, Suwon-si (KR); Young Ghyu AHN, Suwon-si (KR); Hwi Dae KIM, Suwon-si (KR)

(73) Assignee: SAMSUNG ELECTRO-MECHANICS CO., LTD., Suwon-si (KR)

(21) Appl. No.: 18/520,897

(22) Filed: Nov. 28, 2023

(30) Foreign Application Priority Data
Feb. 13, 2023 (KR) 10-2023-0018753

(51) Int. Cl. H01G 4/30; H01G 4/012; H01G 4/12; H01G 4/224; H01G 4/232

(52) U.S. Cl. CPC H01G 4/30; H01G 4/012; H01G 4/12; H01G 4/224; H01G 4/232

(57) ABSTRACT

A multilayer ceramic capacitor includes a body having a capacitance formation region with a plurality of first and second internal electrodes alternately stacked with one of a plurality of dielectric layers interposed therebetween in a first direction, and first and second external electrodes disposed on the body, spaced apart from each other in a second direction, different from the first direction, with the capacitance formation region therebetween, and connected to the plurality of first and second internal electrodes, respectively. The body further includes a plurality of side margin portions disposed to have the capacitance formation region therebetween in a third direction, different from the first and second directions, the plurality of dielectric layers protrude more toward the plurality of side margin portions than the plurality of first and second internal electrodes, and portions of the plurality of respective side margin portions are located between the plurality of dielectric layers.

### CROSS-REFERENCE TO RELATED APPLICATION (S)

This application claims benefit of priority to Korean Patent Application No. 10-2023-0018753 filed on Feb. 13, 2023 in the Korean Intellectual Property Office, the disclosure of which is incorporated herein by reference in its entirety.

### TECHNICAL FIELD

The present disclosure relates to a multilayer ceramic capacitor.

Multilayer ceramic capacitors are widely used as electronic devices components for computers, PDAs, and mobile phones due to a small size, high capacitance, and ease of installation thereof, and are also widely used as components for electrical devices (including vehicles) due to high reliability and high strength thereof.

When multilayer ceramic capacitors are used in electronic devices, the multilayer ceramic capacitors may be miniaturized (and/or implemented with a low profile). As the multilayer ceramic capacitor is further reduced in size, the difficulty in ensuring the reliability of the multilayer ceramic capacitor may increase.

When multilayer ceramic capacitors are used in electrical devices, the multilayer ceramic capacitors may be exposed to harsh environments (e.g., high voltage, high temperature, possibility of external shock), and the reliability of multilayer ceramic capacitors may become more important.

### SUMMARY

An aspect of the present disclosure is to provide a multilayer ceramic capacitor having efficiently improved reliability or advantageous for miniaturization (and/or low profile implementation).

According to an aspect of the present disclosure, a multilayer ceramic capacitor includes a body having a capacitance formation region including a plurality of dielectric layers, and a plurality of first internal electrodes and a plurality of second internal electrodes alternately stacked with one of the plurality of dielectric layers interposed therebetween in a first direction; and a first external electrode and a second external electrode disposed on the body, spaced apart from each other in a second direction, different from the first direction, with the capacitance formation region between the first external electrode and the second external electrode, and connected to the plurality of first internal electrodes and the plurality of second internal electrodes, respectively. The body further includes a plurality of side margin portions disposed to have the capacitance formation region therebetween in a third direction different from the first and second directions, the plurality of dielectric layers, as compared to the plurality of first and second internal electrodes, protrude more toward the plurality of side margin portions, and portions of each of the plurality of side margin portions are located between the plurality of dielectric layers.

According to an aspect of the present disclosure, a multilayer ceramic capacitor includes a body having a capacitance formation region including a plurality of dielectric layers, and a plurality of first internal electrodes and a plurality of second internal electrodes alternately stacked with one of the plurality of dielectric layers interposed therebetween in a first direction; and a first external electrode and a second external electrode disposed on the body, spaced apart from each other in a second direction, different from the first direction, with the capacitance formation region between the first external electrode and the second external electrode, and connected to the plurality of first internal electrodes and the plurality of second internal electrode, respectively. The body further includes a plurality of side margin portions disposed with the capacitance formation region therebetween in a third direction different from the first and second directions, the plurality of side margin portions respectively includes an edge portion covering a portion of an outer surface of each of the first and second external electrodes, and a plurality of cover layers disposed with the capacitance formation region therebetween in the first direction.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1A to 1C are perspective views illustrating a multilayer ceramic capacitor and an interior thereof according to an embodiment;

FIG. 1D is a perspective view illustrating a process of disposing a side margin portion of the multilayer ceramic capacitor on a body according to an embodiment;

FIGS. 2A and 2B are cross-sectional views illustrating the multilayer ceramic capacitor of FIG. 1A and a method of manufacturing the same;

FIGS. 3A and 3B are cross-sectional views illustrating the multilayer ceramic capacitor of FIG. 1B and a method of manufacturing the same;

FIG. 4A is a cross-sectional view illustrating a first method of forming a plurality of side margin portions;

FIG. 4B is a cross-sectional view illustrating a second method of forming a plurality of side margin portions;

FIG. 4C is a cross-sectional view illustrating a third method of forming a plurality of side margin portions;

FIGS. 5A and 5B are perspective views illustrating a multilayer ceramic capacitor and a method of manufacturing the same according to an embodiment;

FIGS. 6A and 6B are perspective views illustrating a multilayer ceramic capacitor and a method of manufacturing the same according to an embodiment; and

FIGS. 7A and 7B are cross-sectional views illustrating a multilayer ceramic capacitor and external electrodes included therein according to an embodiment.

### DETAILED DESCRIPTION

Embodiments may be modified to have various other forms, and the scope of the present disclosure is not limited to the embodiments described below. Additionally, the embodiments are provided to more completely describe the present disclosure to those with average knowledge in the art. Therefore, the shapes and sizes of elements in the drawings may be exaggerated for clearer explanation, and elements indicated by the same symbol in the drawings are the same elements.

In order to clearly describe the present disclosure in the drawings, parts that are not relevant to the description are omitted, and the thickness is enlarged to clearly express the various layers and regions. Components with the same function within the scope of the same idea are described using the same reference numeral.

Throughout the specification, when a part is said to “include” a certain element, this means that it may further include other elements rather than excluding other elements, unless specifically stated to the contrary.

In order to clearly describe the embodiments, if the direction of the hexahedron is defined, X, Y and Z indicated on the drawing represent the length direction, width direction and thickness direction, respectively. In this case, the thickness direction may be used as the same concept as the stacking direction (or first direction) in which the dielectric layers are stacked.

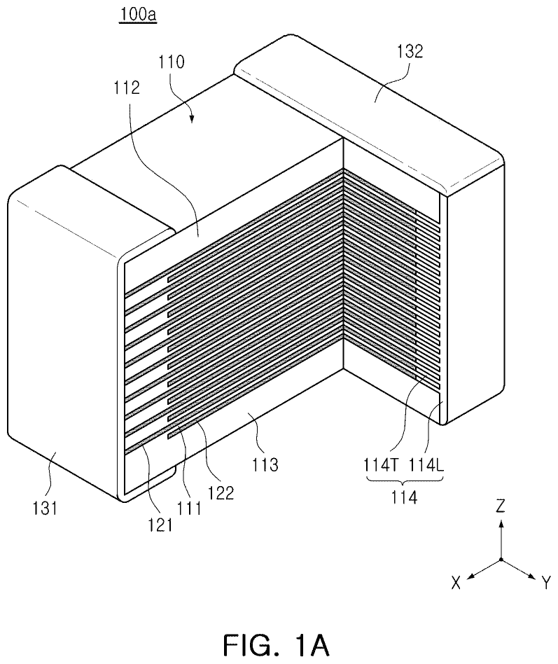

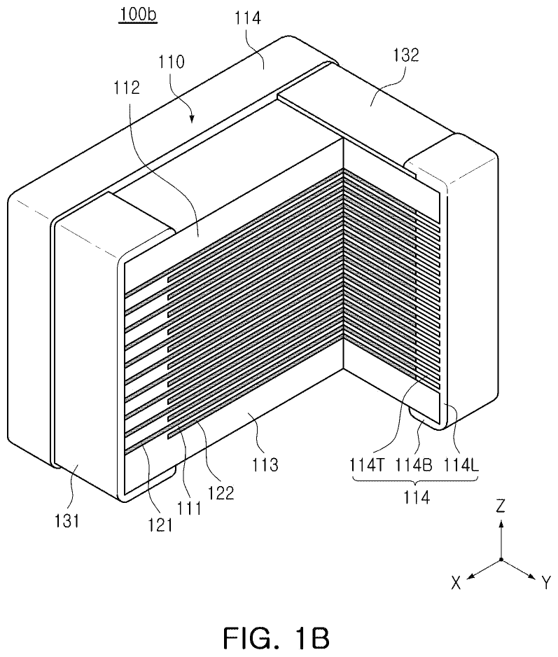

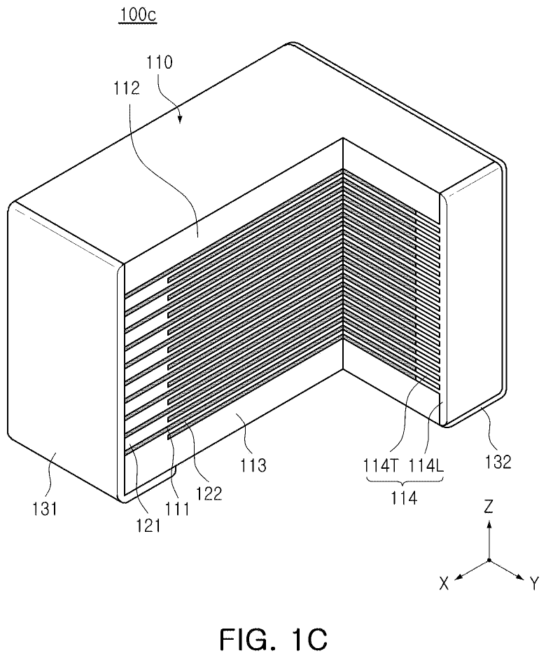

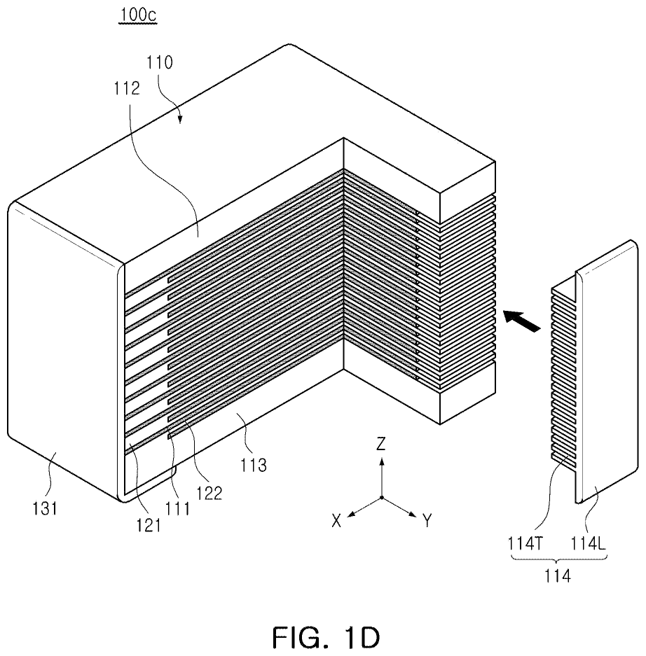

Referring to FIGS. 1A, 1B, 1C, and 1D, multilayer ceramic capacitors 100a, 100b and 100c according to embodiments may include a body 110, a first external electrode 131, and a second external electrode 132.

The body 110 may include a capacitance formation region in which a plurality of first internal electrodes 121 and a plurality of second internal electrodes 122 are alternately stacked with one of the plurality of dielectric layers 111 therebetween in the first direction (e.g., Z-direction).

For example, the body 110 may be formed of a ceramic body by sintering the capacitance formation region. In this case, the plurality of dielectric layers 111 disposed in the body 110 are in a sintered state, and the boundaries between adjacent dielectric layers may be integrated to the extent that it is difficult to check without using a scanning electron microscope (SEM).

For example, the body 110 may be formed as a hexahedron having both sides in the longitudinal direction (X), both sides in the width direction (Y), and both sides in the thickness direction (Z), and the edges and/or corners of the hexahedron may be rounded as they are polished. However, the shape and dimensions of the body 110 and the number of stacks of the dielectric layers 111 are not limited to those shown in this embodiment.

The thickness of the plurality of dielectric layers 111 may be arbitrarily changed to match the capacitance design of the multilayer ceramic capacitors 100a, 100b, and 100c, and may include ceramic powder having a high dielectric constant, for example, barium titanate (BaTiO₃)-based powder, and the present disclosure is not limited thereto. In addition, according to the required specifications of the multilayer ceramic capacitors 100a, 100b and 100c, various ceramic additives (e.g. Mgo, Al₂O₃, SiO₂, ZnO), organic solvents, plasticizers, binders, dispersants, and the like may be added to ceramic powder.

The average particle size of the ceramic powder used to form the plurality of dielectric layers 111 is not particularly limited, and may be adjusted depending on required specifications (example: miniaturization and/or high capacitance required for, for example, capacitors for electronic devices, or high withstand voltage characteristics and/or strong strength required for, for example, capacitors for electrical devices, or the like) for multilayer ceramic capacitors 100a, 100b and 100c, and for example, may be adjusted to be 400 nm or less.

For example, the plurality of dielectric layers 111 may be formed by applying and drying a slurry containing powder such as barium titanate (BaTiO₃) or the like on a carrier film to prepare a plurality of ceramic sheets. The ceramic sheet may be formed by mixing ceramic powder, a binder, and a solvent to prepare a slurry, and manufacturing the slurry into a sheet with a thickness of several μm using a doctor blade method, but the present disclosure is not limited thereto.

A plurality of first internal electrodes 121 and a plurality of second internal electrodes 122 are formed by printing a conductive paste containing a conductive metal, to be alternately exposed to one side and the other side of the body 110 in the longitudinal direction (X), in the stacking direction (e.g., Z-direction) of the dielectric layer, and may be electrically insulated from each other by a dielectric layer disposed therebetween.

For example, the plurality of first internal electrodes 121 and the plurality of second internal electrodes 122 may be respectively formed by a conductive paste for internal electrodes having an average particle size of 0.1 to 0.2 μm and 40 to 50% by weight of a conductive metal powder, but the present disclosure is not limited thereto. The conductive paste may be formed of nickel (Ni), copper (Cu), palladium (Pd), silver (Ag), lead (Pb), or platinum (Pt) alone or alloys thereof, but the present disclosure is not limited thereto.

For example, the internal electrode pattern may be formed by applying the conductive paste for internal electrodes on the ceramic sheet using a printing method or the like. Examples of the printing method of the conductive paste may include screen-printing, gravure printing, and inkjet printing, but the present disclosure is not limited thereto. For example, the body 110 may be manufactured by stacking 200 to 300 layers of ceramic sheets on which the internal electrode patterns are printed, pressing and firing the same.

The capacitance of the multilayer ceramic capacitors 100a, 100b, and 100c may be proportional to the overlap area in the stacking direction (e.g., Z-direction) between the plurality of first internal electrodes 121 and the plurality of second internal electrodes 122, may be proportional to the total number of stacks of the plurality of first internal electrodes 121 and the plurality of second internal electrodes 122, and may be inversely proportional to the distance between the plurality of first internal electrodes 121 and the plurality of second internal electrodes 122. The distance between internal electrodes may be substantially equal to the thickness of each of the plurality of dielectric layers 111.

The multilayer ceramic capacitors 100a, 100b, and 100c may have a larger capacitance compared to the thickness thereof as the distance between the plurality of first internal electrodes 121 and the plurality of second internal electrodes 122 is relatively shorter. On the other hand, the withstand voltage of the multilayer ceramic capacitors 100a, 100b, and 100c may be higher as the interval between the internal electrodes is greater. Therefore, the internal electrode spacing may be adjusted according to the required specifications of the multilayer ceramic capacitors 100a, miniaturization and/or high 100b, and 100c (e.g., capacitance required for, for example, capacitors for electronic devices, high withstand voltage characteristics and/or strong strength for, for example, capacitors for electrical devices). The thickness of each of the plurality of first internal electrodes 121 and the plurality of second internal electrodes 122 may also be affected by the internal electrode spacing.

For example, in the multilayer ceramic capacitors 100a, 100b and 100c, when relatively high withstand voltage characteristics and/or strong strength are required, the gap between the plurality of first internal electrodes 121 and the plurality of second internal electrodes 122 may be designed to exceed twice the thickness of each thereof. For example, when miniaturization and/or high capacitance are required, the multilayer ceramic capacitors 100a, 100b and 100c may be designed such that the thickness of each of the plurality of first internal electrodes 121 and the plurality of second internal electrodes 122 may be 0.4 μm or less and the total number of stacked layers may be 400 or more.

The first and second external electrodes 131 and 132 may be disposed on the body 110 to be spaced apart from each other with a capacitance formation region therebetween in a second direction (e.g., X-direction) different from the first direction (e.g., Z-direction), and may be connected to a plurality of first internal electrodes 121 and a plurality of second internal electrodes 122, respectively.

For example, the first and second external electrodes 131 and 132 may be respectively formed by dipping into a paste containing metal components, printing a conductive paste, a sheet transfer, a pad transfer, a sputter plating, an electrolytic plating, or the like. The metal component may be copper (Cu), nickel (Ni), palladium (Pd), platinum (Pt), gold (Au), silver (Ag), lead (Pb), tin (Sn) alone or alloys thereof, but the present disclosure is not limited thereto.

The multilayer ceramic capacitors 100a, 100b, and 100c may be mounted or embedded in an external board (e.g., a printed circuit board), be connected to at least one of the wiring, land, solder, and bump of the external board through the first and second external electrodes 131 and 132, and may thus be electrically connected to a circuit (e.g., an integrated circuit, a processor) electrically connected to the external board.

Referring to FIGS. 1A, 1B, 1C, and 1D, the body 110 may include at least one of a plurality of cover layers 112 and 113 and a plurality of side margin portions 114.

The plurality of cover layers 112 and 113 may be disposed with the capacitance formation region therebetween in the first direction (e.g., Z-direction). Each of the plurality of cover layers 112 and 113 may be thicker than the thickness of each of the plurality of dielectric layers 111, and may provide the upper and lower surfaces of the body 110. A portion of each of the first and second external electrodes 131 and 132 may be disposed on the lower surface and/or upper surface of the body 110.

The plurality of cover layers 112 and 113 may prevent external environmental factors (e.g., moisture, plating solution, foreign substances) from penetrating into the capacitance formation region, protect the body 110 from external shocks, and improve bending strength of the body 110. For example, the plurality of cover layers 112 and 113 may include the same material as the material of the plurality of dielectric layers 111 or a different material (e.g., a thermosetting resin such as epoxy resin).

The plurality of side margin portions 114 may be disposed with the capacitance formation region therebetween in a third direction (e.g., Y-direction) different from the first and second directions (e.g., Z-direction and X-direction). The plurality of side margin portions 114 may prevent the plurality of first internal electrodes 121 and the plurality of second internal electrodes 122 from being exposed to the surface of the body 110 in the third direction (e.g., Y-direction), and may thus prevent external environmental factors (e.g., moisture, plating solution, foreign substances) from penetrating into the plurality of first internal electrodes 121 and the plurality of second internal electrodes 122 through the surface of the body in the third direction, thereby improving the reliability and lifespan of the multilayer ceramic capacitors 100a, 100b, and 100c. In addition, the plurality of first internal electrodes 121 and the plurality of second internal electrodes 122 may be efficiently expanded in the third direction due to the plurality of side margin portions 114. Therefore, the plurality of side margin portions 114 may contribute to improving the capacitance of the multilayer ceramic capacitors 100a, 100b, and 100c by increasing the overlapping area of the plurality of first internal electrodes 121 and the plurality of second internal electrodes 122.

Referring to FIGS. 1A, 1B, 1C, and 1D, the plurality of dielectric layers 111 protrude more toward the plurality of side margin portions 114 than the plurality of first and second internal electrodes 121 and 122, and portions of the plurality of respective side margin portions 114 may be located between the plurality of dielectric layers 111. Protrusions 114T of the plurality of respective side margin portions 114 may protrude from the margin layers 114L of the plurality of respective side margin portions 114 toward the plurality of first internal electrodes 121 and the plurality of second internal electrodes 122, and may overlap the plurality of dielectric layers 111 in the first direction (e.g., Z-direction). For example, the margin layer 114L is exposed to the outside of the body 110, and the protrusion 114T may contact the plurality of first internal electrodes 121 and the plurality of second internal electrodes 122.

Accordingly, since the distance between the plurality of first internal electrodes 121 or the plurality of second internal electrodes 122 and the surface of the body 110 in the third direction may correspond to the sum of the protrusion length of the protrusion 114T and the thickness of the margin layer 114L, external environmental factors (e.g., moisture, plating solution, foreign substances) may be more efficiently prevented from penetrating into the plurality of first internal electrodes 121 and the plurality of second internal electrodes 122 through the surface of the body in the third direction (e.g., Y-direction). In this case, efficiency may mean that the ratio of the degree to which the performance of the plurality of side margin portions 114 in preventing penetration of external environmental factors is further improved compared to the degree to which the width of the body 110 in the third direction (e.g., Y-direction) is increased is high, as the plurality of side margin portions 114 are added to the body 110. This is because, among the protrusion 114T and the margin layer 114L, only the margin layer 114L has a substantial effect on the width of the body 110.

The fact that the protrusion 114T protrudes from each of the plurality of side margin portions 114 means that the protrusion 114T and the margin layer 114L are integrated with each other, or means that the protrusion 114T and the margin layer 114L do not form an interface therebetween. For example, the protrusion 114T and the margin layer 114L may contain the same insulating material.

For example, Young's modulus of each of the plurality of side margin portions 114 may be less than 50 GPa. Accordingly, when the plurality of side margin portions 114 are formed, portions of the plurality of side margin portions 114 may easily flow to the upper and/or lower surfaces of the plurality of dielectric layers 111 while contacting the side surfaces of the plurality of dielectric layers 111, thereby forming the protrusions 114T.

Accordingly, the protrusion 114T may be formed without an additional process when forming the plurality of side margin portions 114. In addition, the plurality of side margin portions 114 may be formed without the known Margin Formation (MF) method, and may be formed without being substantially limited by the size of the body 110. For example, if the thickness of the body 110 in the first direction (e.g., Z-direction) is very thin, such as less than 100 μm, it may be difficult to rotate the body 110 by 90 degrees in the MF method, but the plurality of side margin portions 114 may be formed without rotating the body 110. The plurality of side margin portions 114 may be formed efficiently even when the body 110 has a low profile structure. The thickness of the body may be measured by microscopy (e.g., electron microscopy) and other methods and/or tools appreciated by one of ordinary skill in the art, even if not described in the present disclosure.

Young's modulus may be measured by identifying the main material contained in the plurality of side margin portions 114 and the plurality of dielectric layers 111. For example, Energy Dispersive X-ray Spectroscopy (EDS) analysis may be used to identify main materials contained in the plurality of side margin portions 114 and the plurality of dielectric layers 111. To describe EDS analysis in detail, the cross section exposed by cutting or polishing the body 110 of the sample of the multilayer ceramic capacitor along the X-Z plane including the center may be pretreated (e.g. fixation of the sample and coating with a material with low electrical conductivity), and an electron beam may be scanned onto the pretreated sample. At this time, each part of the sample may emit X-rays while stabilizing in an excited state according to the electron beam, and the energy value of X-rays may vary depending on the material of each part of the sample. Therefore, the collector may collect the X-ray, and the computing system may identify the substances in respective parts of the sample by comparing whether the energy value of the X-ray falls within a specific numerical range, and may determine the Young's modulus of the corresponding part based on the substances. Other methods and/or tools appreciated by one of ordinary skill in the art, even if not described in the present disclosure, may also be used.

When the plurality of dielectric layers 111 contain a barium titanate (BaTiO₃)-based main material, since the Young's modulus of barium titanate (BaTiO₃) is 135 GPa, the Young's modulus of the plurality of dielectric layers 111 may be substantially equal to 135 GPa. The Young's modulus of the main material of the plurality of side margin portions 114 is less than 50 GPa and therefore may be significantly lower than 135 GPa. For example, the plurality of side margin portions 114 may include at least one of insulating polymer, epoxy, and Ajinomoto Build-up Film (ABF) having a Young's modulus of less than 50 GPa. The Young's modulus of ABF may be about 5 GPa, and the Young's modulus of epoxy may be about 4 GPa. However, the main material of the plurality of side margin portions 114 is not limited to ABF or epoxy, and any insulating material (e.g., organic material such as polyimide or insulating polymer) of less than 50 GPa may be selectively used in the plurality of side margin portions 114.

Since the protrusions 114T and the margin layers 114L of the plurality of side margin portions 114 may be integrated with each other, and the protrusions 114T and the margin layers 114L may contain the same insulating material as each other, and the Young's modulus of each of the protrusions 114T and the margin layers 114L may be less than 50 GPa.

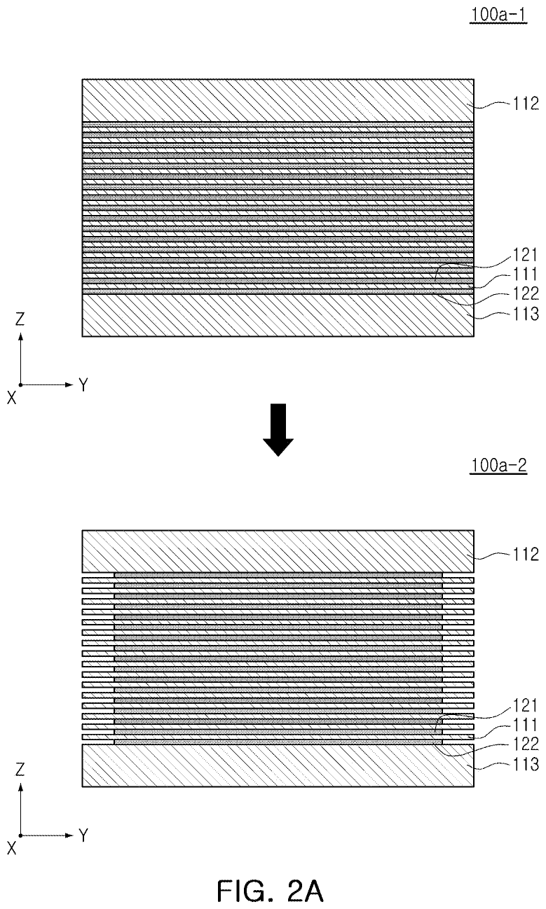

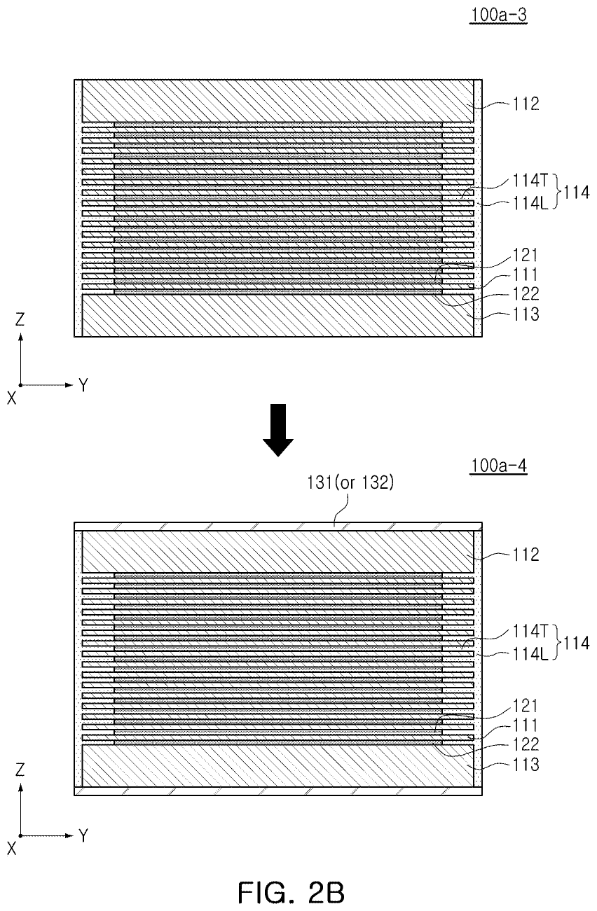

Referring to FIGS. 1A and 2A, a multilayer ceramic capacitor 100a-1 of a first stage may have a structure in which the third-direction (e.g. Y-direction) side surfaces of the plurality of dielectric layers 111, the third-direction side surfaces of the plurality of first internal electrodes 121 and the third-direction side surfaces of the plurality of second internal electrodes 122 form one plane with each other. The one plane may be a cutting plane. Thereafter, the multilayer ceramic capacitor 100a-1 of the first stage may be fired before the etching process.

Referring to FIGS. 1A and 2A, a multilayer ceramic capacitor 100a-2 of a second stage may have a structure in which third-direction ends of the plurality of first internal electrodes 121 and third-direction ends of the plurality of second internal electrodes 122 have been removed by an etching process. For example, the etching process may be chemical etching using an etching solution that may selectively etch a material (e.g., nickel) contained in the plurality of first internal electrodes 121 and the plurality of second internal electrodes 122.

Referring to FIGS. 1A and 2B, a multilayer ceramic capacitor 100a-3 of a third stage may have a structure in which the protrusions 114T of the plurality of side margin portions 114 cover the plurality of first internal electrodes 121 and the plurality of second internal electrodes 122 in the third direction (e.g., Y-direction) and a structure in which the margin layer 114L covers the plurality of dielectric layers 111 in the third direction.

Referring to FIGS. 1A and 2B, a multilayer ceramic capacitor 100a-4 of a fourth stage may have a structure in which the first external electrode 131 or the second external electrode 132 covers the plurality of cover layers 112 and 113 in the first direction (e.g., Z-direction).

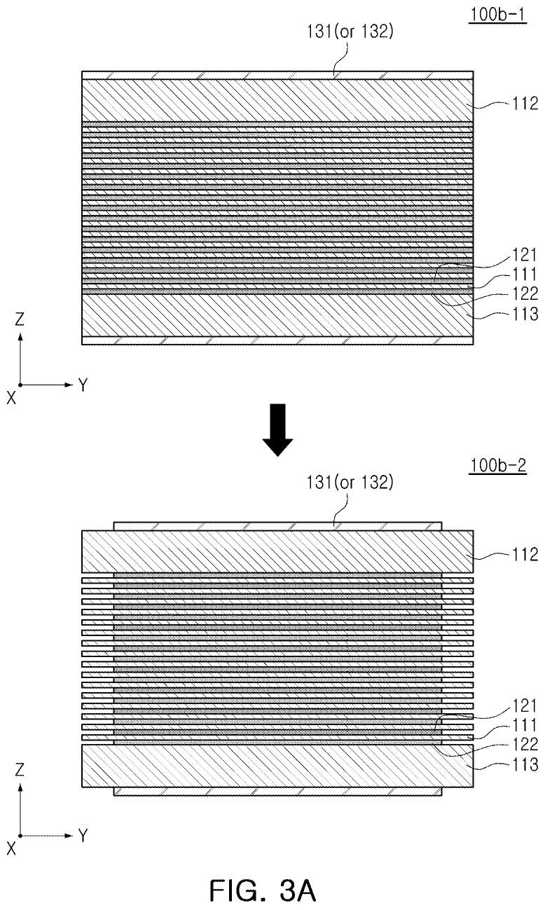

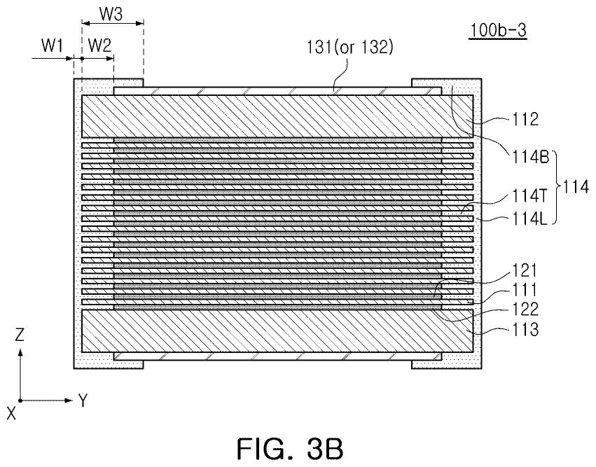

Referring to FIGS. 1B and 3A, in a multilayer ceramic capacitor 100b-1 of a first stage, the third-direction (e.g. Y-direction) side surfaces of the plurality of dielectric layers 111, the third-direction side surfaces of the plurality of first internal electrodes 121, the third-direction side surfaces of the plurality of second internal electrodes 122 and the third-direction side surface of the first external electrode 131 or the second external electrode 132 may form one plane with each other.

Referring to FIGS. 1B and 3A, a multilayer ceramic capacitor 100b-2 of a second stage may have a structure in which third-direction ends of the plurality of first internal electrodes 121, third-direction ends of the plurality of second internal electrodes 122 and the third-direction end of the first external electrode 131 or the second external electrode 132 have been removed by an etching process. Depending on the design, the first external electrode 131 and the second external electrode 132 may contain other materials (e.g. copper), and the ends of the first external electrode 131 and the second external electrode 132 in the third direction may not be etched.

Referring to FIG. 3B, a multilayer ceramic capacitor 100b-3 of a third stage may have a structure in which the protrusions 114T of the plurality of side margin portions 114 cover the plurality of first internal electrodes 121 and the plurality of second internal electrodes 122 in the third direction (e.g., Y-direction), have a structure in which the margin layer 114L covers the plurality of dielectric layers 111 in the third direction, and have a structure in which an edge portion 114B covers a portion of the outer surface of the first external electrode 131 and/or the second external electrode 132 in the first direction (e.g., Z-direction).

Therefore, a portion of each of the first and second external electrodes 131 and 132 may be disposed between the edge portion 114B of each of the plurality of side margin portions 114 and a cover layer disposed closer to the edge portion 114B among the plurality of cover layers 112 and 113. The edge portion 114B may have a structure extending from the margin layer 114L in a first direction (e.g., Z-direction) and bent in a third direction (e.g., Y-direction) to cover portions of the outer surfaces of the first and second external electrodes 131 and 132, respectively. The edge portion 114B may be formed in a similar manner to the principle by which the protrusion 114T is formed, and may be formed almost simultaneously with the protrusion 114T.

The edge portion 114B, the margin layer 114L, and the protrusions 114T may be integrated with each other and may not form an interface therebetween. For example, the edge portion 114B, the margin layer 114L, and the protrusion 114T may contain the same insulating material, and the Young's modulus of each of the edge portion 114B, the margin layer 114L, and the protrusion 114T may be less than 50 GPa.

Since the spatial margin of the edge portion 114B may be greater than the spatial margin of the protrusion 114T, a third-direction length W3 of the edge portion 114B may be longer than a protrusion length W2 of the protrusion 114T, but is not limited thereto.

For example, the protrusion length W2 of the protrusion 114T and the third-direction length W3 of the edge portion 114B may each be greater than 1 μm and less than 20 μm, and may be greater than a thickness W1 of the margin layer 114L. W1, W2, and W3 may be measured as the average value of the portions corresponding to W1, W2, and W3 in the YZ cross section of the multilayer ceramic capacitor formed by polishing the multilayer ceramic capacitor in the X-direction. For example, the YZ cross-section may be subjected to analysis using at least one of a Transmission Electron Microscope (TEM), an Atomic Force Microscope (AFM), a Scanning Electron Microscope (SEM), an optical microscope, and a surface profiler, while W1, W2 and W3 may be measured by visual confirmation of the image obtained according to the above analysis or by image processing (e.g., identifying pixels based on color or brightness of the pixels, filtering pixel values for pixel identification efficiency, integrating distances between identified pixels, and the like). Other methods and/or tools appreciated by one of ordinary skill in the art, even if not described in the present disclosure, may also be used.

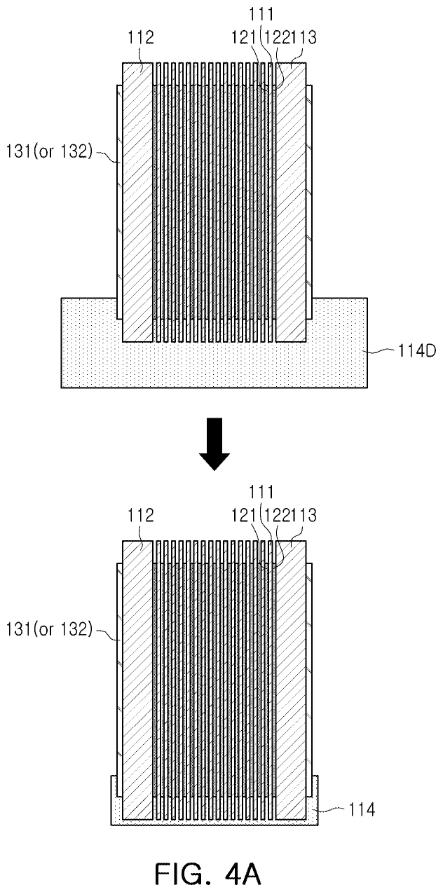

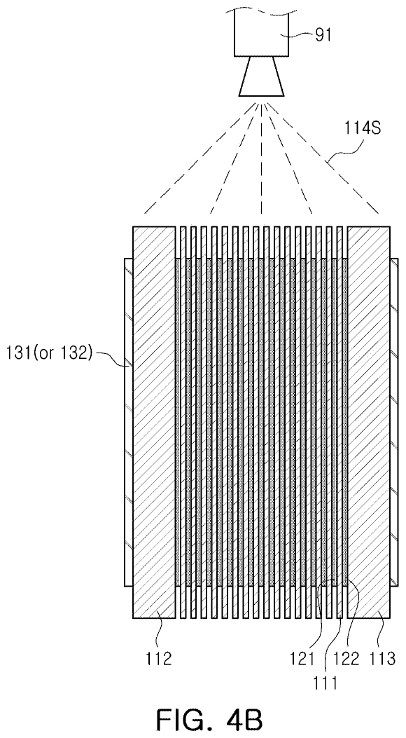

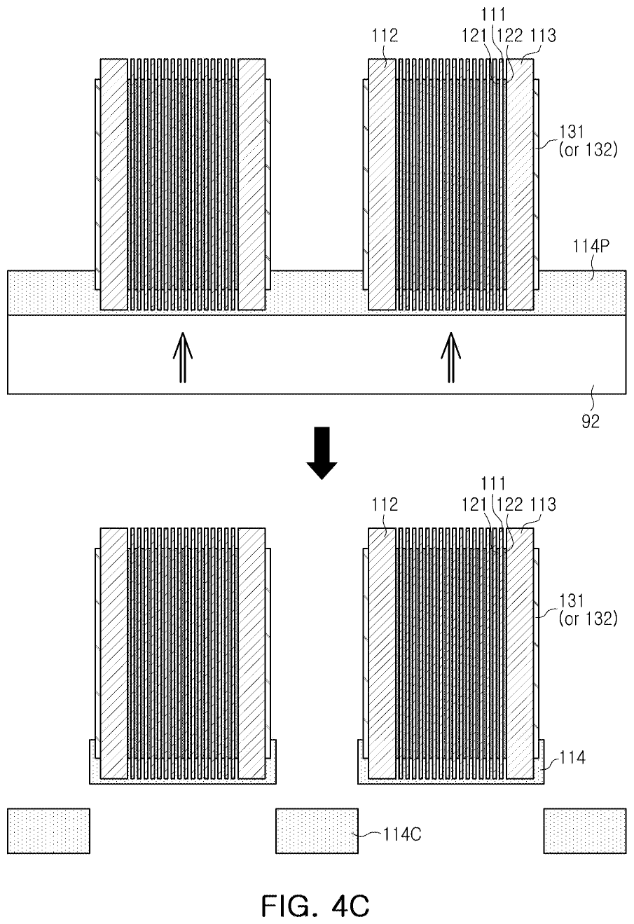

Referring to FIG. 4A, a portion of the multilayer ceramic capacitor in which the third-direction ends of the plurality of first internal electrodes 121 and the plurality of second internal electrodes 122 have undergone the etching process may be immersed in an insulating pool 114D in a liquid state. Accordingly, one of the plurality of side margin portions 114 may be formed, which may be expressed in a dipping method.

Referring to FIG. 4B, a spray 91 may spray insulating particles 114S onto the surface of the multilayer ceramic capacitor in the third direction. Accordingly, one of the plurality of side margin portions 114 may be formed.

Referring to FIG. 4C, an insulating sheet 114P may be disposed on a support 92 and attached to the surface of the multilayer ceramic capacitor in the third direction according to a thermocompression method. For example, the ambient temperature may be, but is not limited to, 50 to 150 degrees Celsius. A portion 114C of the insulating sheet 114P may be separated by cutting after being attached to the surface of the multilayer ceramic capacitor in the third direction. Accordingly, one of the plurality of side margin portions 114 may be formed.

Depending on the design, the plurality of side margin portions 114 may be formed by ceramic atomic layer deposition or ceramic sputtering. In this case, the ceramic material may be a composition designed so that the Young's modulus of the plurality of side margin portions 114 is less than 50 GPa.

Referring to FIG. 1C, a portion of the first external electrode 131 may overlap the body 110 in a first direction (e.g., Z-direction), and the remainder of the first external electrode 131 may not overlap the body 110 in a first direction (e.g., Z-direction). A portion of the second external electrode 132 may overlap the body 110 in the first direction (e.g., Z-direction) and the remainder of the second external electrode 132 may not overlap the body in the first direction (e.g., Z-direction). For example, each of the first and second external electrodes 131 and 132 may have an L shape.

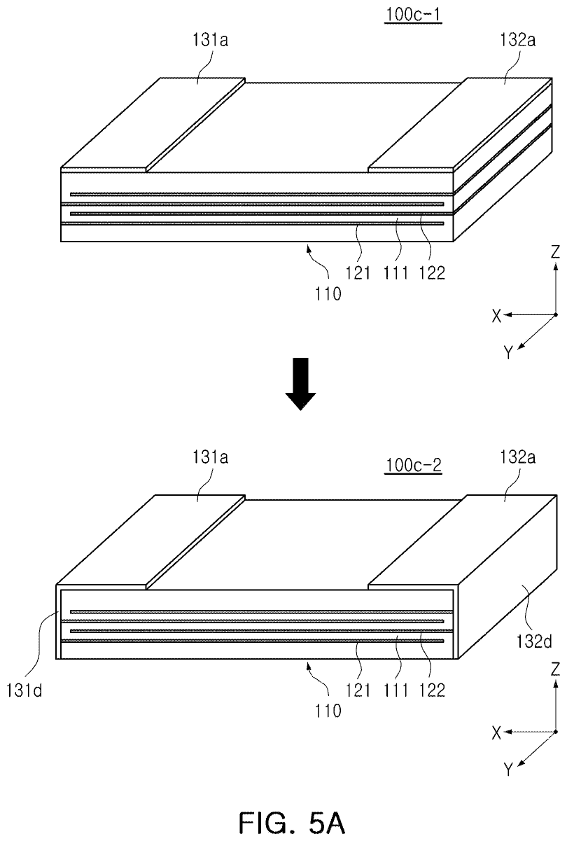

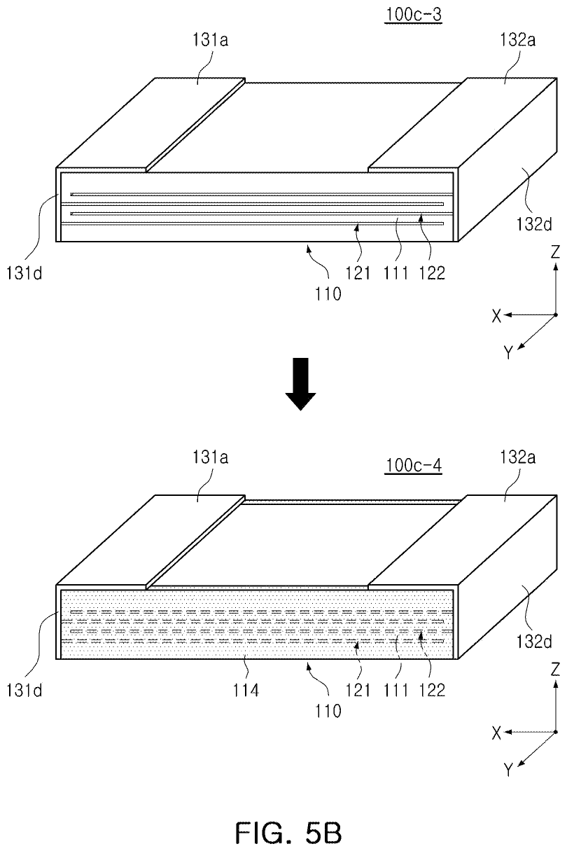

Referring to FIGS. 1C and 5A, a multilayer ceramic capacitor 100c-1 of a first stage may have a structure in which a base electrode layer 131a of the first external electrode 131 and a base electrode layer 132a of the second external electrode 132 are disposed on the upper surface of the body 110.

Referring to FIGS. 1C and 5A, a multilayer ceramic capacitor 100c-2 of a second stage may have a structure in which a connection electrode layer 131d of the first external electrode 131 and a connection electrode layer 132d of the second external electrode 132 are disposed on the side of the body 110 in the second direction (e.g., X-direction). The connection electrode layers 131d and 132d may be connected to the plurality of first internal electrodes 121 and the plurality of second internal electrodes 122, and the edges of the connection electrode layers 131d and 132d may be connected to the edges of the base electrode layers 131a and 132a.

Referring to FIGS. 1C and 5B, a multilayer ceramic capacitor 100c-3 of a third stage may have a structure in which the third-direction ends of the plurality of first internal electrodes 121 and the third-direction ends of the plurality of second internal electrodes 122 have been removed by an etching process. A multilayer ceramic capacitor 100c-4 of a fourth stage may have a structure in which a plurality of side margin portions 114 are formed. The connection electrode layers 131d and 132d may prevent the ends of the plurality of first internal electrodes 121 in the second direction (e.g., X-direction) and the ends of the plurality of second internal electrodes 122 in the second direction from being etched when the etching process for the ends thereof in the third direction is performed.

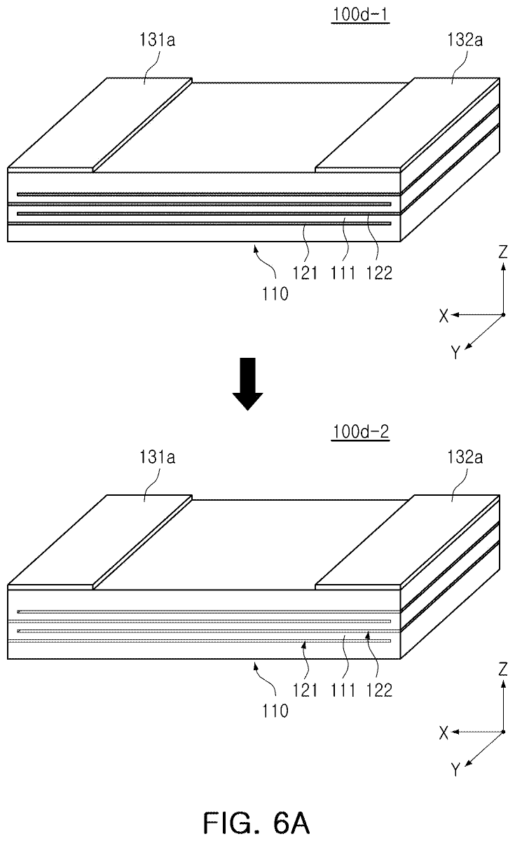

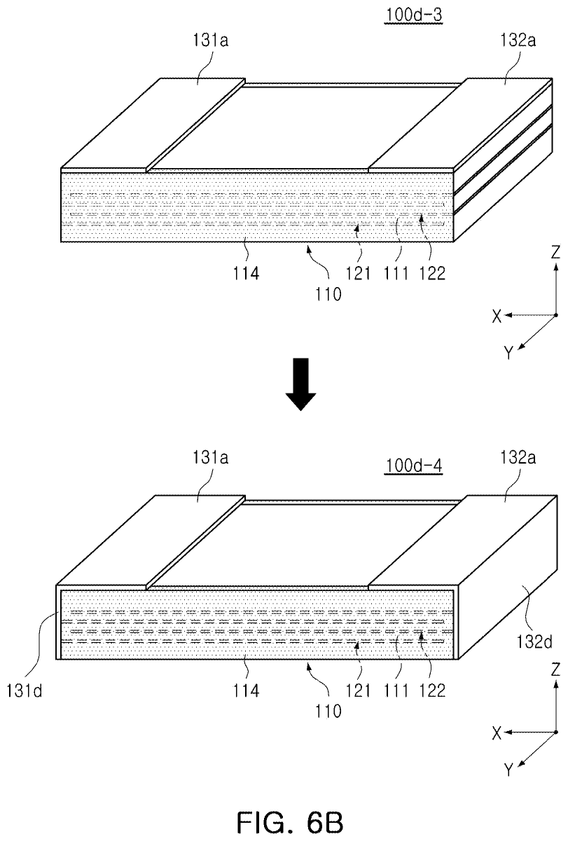

Referring to FIG. 6A, a multilayer ceramic capacitor 100d-1 of a first stage may have a structure in which a base electrode layer 131a of the first external electrode 131 and a base electrode layer 132a of the second external electrode 132 are disposed on the upper surface of the body 110. A multilayer ceramic capacitor 100d-2 of a second stage may have a structure in which the third-direction ends of the plurality of first internal electrodes 121 and the third-direction ends of the plurality of second internal electrodes 122 have been removed by an etching process.

Referring to FIG. 6B, a multilayer ceramic capacitor 100d-3 of a third stage may have a structure in which a plurality of side margin portions 114 are formed, and a multilayer ceramic capacitor 100d-4 of a fourth stage may have a structure in which connection electrode layers 131d and 132d are formed.

Referring to FIGS. 5B and 6B, the first and second external electrodes, which are in a combination structure of the base electrode layer 131a and the connection electrode layers 131d and 132d, may be disposed so as not to overlap the body 110 in the third direction (e.g., W direction). For example, the base electrode layer 131a and the connection electrode layers 131d and 132d may be respectively formed by a plating process such as sputtering or Chemical Vapor Deposition (CVD), but the present disclosure is not limited thereto.

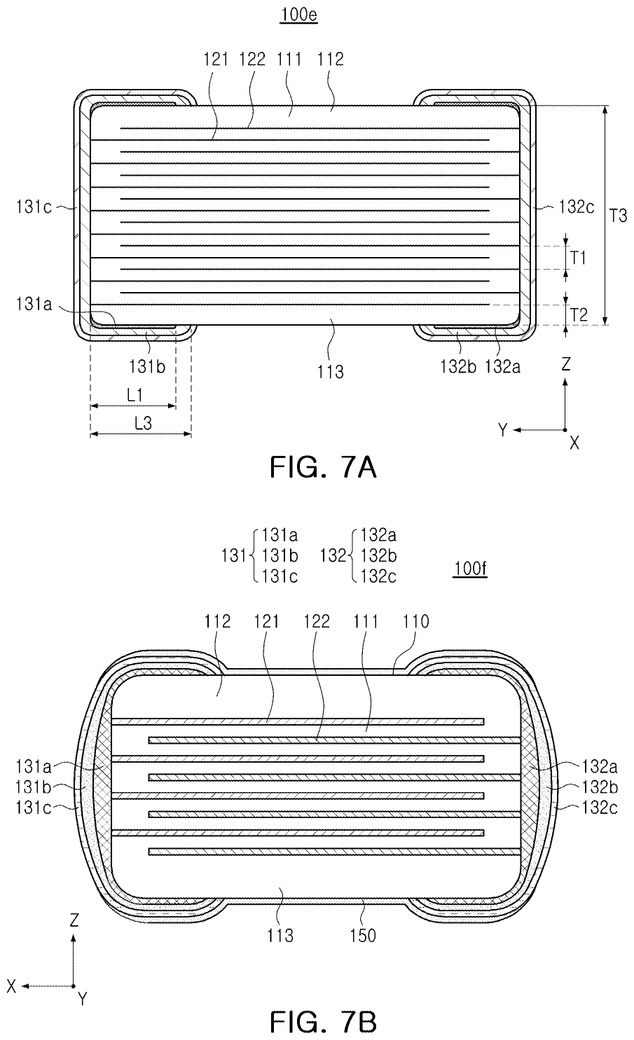

Referring to FIGS. 7A and 7B, first and second external electrodes multilayer ceramic capacitors 100e and 100f according to embodiments may include at least one of base electrode layers 131a and 132a, connection electrode layers 131b and 132b, and plating layers 131c and 132c.

The base electrode layers 131a and 132a, and the connection electrode layers 131b and 132b of FIG. 7A may be respectively formed by dipping a portion of the body 110 into a paste containing a metal material and/or a glass frit or by firing the paste while it is printed on a portion of the body 110, and may also be formed by sheet transfer or pad transfer methods. The metal material may be copper (Cu) to improve electrical connectivity to the body 110, but is not limited thereto. For example, the metal material may include at least one of copper (Cu), nickel (Ni), palladium (Pd), platinum (Pt), gold (Au), silver (Ag), and lead (Pb), and may vary depending on the metal material of the internal electrode in the body 110.

Depending on the design, the connection electrode layers 131b and 132b of FIG. 7B may be formed of a conductive resin layer. For example, the conductive resin layer may include a thermosetting resin such as epoxy and a plurality of conductive particles (e.g., the same metal material as the base electrode layer). However, it is not limited to the above thermosetting resin, and the conductive resin layer may include bisphenol A resin, glycol epoxy resin, novolac epoxy resin, or a resin having a low molecular weight and being liquid at room temperature among derivatives thereamong. The conductive resin layer may improve the durability of the first and second external electrodes 131 and 132 against external shock or prevent external moisture or plating solution from penetrating into the body 110. Accordingly, the conductive resin layer may reduce the rate at which the reliability of the first and second external electrodes 131 and 132 deteriorates even when the first and second external electrodes 131 and 132 are exposed to a harsh environment.

The plating layers 131c and 132c may be formed by sputtering or electrolytic plating (electric deposition), but are not limited thereto. For example, the plating layers 131c and 132c may include an inner plating layer containing nickel (Ni) and an outer plating layer containing tin (Sn).

The coating layer 150 of FIG. 7B may cover the outer surfaces of the plurality of cover layers 112 and 113, and may further cover portions of the first and second external electrodes 131 and 132 and/or the outer surfaces of the plurality of side margin portions depending on the design. For example, the coating layer 150 may be composed of an organic/inorganic compound containing Si to improve the moisture resistance reliability of the body 110, and may be composed of organic/inorganic and polymer components containing fluorine (F). For example, the coating layer 150 may be implemented with a silane coupling agent or silicone-resin to have water-repellent performance.

As set forth above, a multilayer ceramic capacitor according to an embodiment may be advantageous in efficiently improving lateral reliability (e.g., preventing penetration of external environmental factors) or in miniaturization (and/or implementing a low profile).

While example embodiments have been shown and described above, it will be apparent to those skilled in the art that modifications and variations could be made without departing from the scope of the present disclosure as defined by the appended claims.

What is claimed is:

1. A multilayer ceramic capacitor comprising:
a body including a capacitance formation region including a plurality of dielectric layers, and a plurality of first internal electrodes and a plurality of second internal electrodes alternately stacked with one of the plurality of dielectric layers interposed therebetween in a first direction; and
a first external electrode and a second external electrode disposed on the body, spaced apart from each other in a second direction different from the first direction, with the capacitance formation region between the first external electrode and the second external electrode, and connected to the plurality of first internal electrodes and the plurality of second internal electrodes, respectively,
wherein the body further includes a plurality of side margin portions disposed to have the capacitance formation region therebetween in a third direction different from the first and second directions,
the plurality of dielectric layers, as compared to the plurality of first and second internal electrodes, protrude more toward the plurality of side margin portions, and
portions of each of the plurality of side margin portions are located between the plurality of dielectric layers.

2. The multilayer ceramic capacitor of claim 1, wherein the plurality of side margin portions respectively includes at least one of insulating polymer, epoxy, and Ajinomoto Build-up Film (ABF).

3. The multilayer ceramic capacitor of claim 1, wherein Young's modulus of each of the plurality of side margin portions is less than 50 GPa.

4. The multilayer ceramic capacitor of claim 1, wherein the plurality of side margin portions respectively includes a protrusion protruding between the plurality of dielectric layers, and a margin layer overlapping the plurality of dielectric layers in the third direction,
wherein the protrusion and the margin layer include the same insulating material.

5. The multilayer ceramic capacitor of claim 4, wherein the margin layer is exposed to an outside of the body, and
the protrusion contacts the plurality of first internal electrodes and the plurality of second internal electrodes.

6. The multilayer ceramic capacitor of claim 4, wherein a protrusion length of the protrusion is greater than a thickness of the margin layer.

7. The multilayer ceramic capacitor of claim 4, wherein a protrusion length of the protrusion is greater than 1 μm and less than 20 μm.

8. The multilayer ceramic capacitor of claim 1, wherein the first and second external electrodes are respectively disposed so as not to overlap the capacitance formation region in the third direction.

9. The multilayer ceramic capacitor of claim 1, wherein the body further includes a plurality of cover layers disposed with the capacitance formation region therebetween in the first direction, and
the plurality of side margin portions respectively includes an edge portion covering a portion of an outer surface of each of the first and second external electrodes in the first direction.

10. The multilayer ceramic capacitor of claim 4, wherein the protrusion is integral with the margin layer.

11. The multilayer ceramic capacitor of claim 10, wherein the plurality of side margin portions respectively includes an edge portion covering a portion of an outer surface of each of the first and second external electrodes in the first direction, and the edge portion, the margin layer, and the protrusion are integral with each other.

12. The multilayer ceramic capacitor of claim 1, wherein a thickness of the body along the first direction is less than 100 μm.

13. The multilayer ceramic capacitor of claim 3, wherein the Young's modulus of each of the plurality of side margin portions is less than Young's modulus of the plurality of dielectric layers.

14. A multilayer ceramic capacitor comprising:
a body including a capacitance formation region including a plurality of dielectric layers, and a plurality of first internal electrodes and a plurality of second internal electrodes alternately stacked with one of the plurality of dielectric layers interposed therebetween in a first direction; and
a first external electrode and a second external electrode disposed on the body, spaced apart from each other in a second direction different from the first direction, with the capacitance formation region between the first external electrode and the second external electrode, and connected to the plurality of first internal electrodes and the plurality of second internal electrode, respectively,
wherein the body further includes,
a plurality of side margin portions disposed with the capacitance formation region therebetween in a third direction different from the first and second directions, the plurality of side margin portions respectively includes an edge portion covering a portion of an outer surface of each of the first and second external electrodes, and
a plurality of cover layers disposed with the capacitance formation region therebetween in the first direction.

15. The multilayer ceramic capacitor of claim 14, wherein the plurality of side margin portions respectively includes at least one of insulating polymer, epoxy, and Ajinomoto Build-up Film (ABF).

16. The multilayer ceramic capacitor of claim 14, wherein the plurality of side margin portions respectively further includes a protrusion protruding toward the plurality of first internal electrodes and the plurality of second internal electrodes in the third direction and overlapping the plurality of dielectric layers in the first direction,
wherein the protrusion and the edge portion include the same insulating material.

17. The multilayer ceramic capacitor of claim 14, wherein the plurality of side margin portions respectively further includes a margin layer overlapping the plurality of dielectric layers in the third direction,
wherein the margin layer and the edge portion are exposed to an outside of the body, and the margin layer and the edge portion contain the same insulating material.

18. The multilayer ceramic capacitor of claim 17, wherein a length of the edge portion in the third direction is greater than a thickness of the margin layer, and
wherein the length of the edge portion in the third direction is greater than 1 μm and less than 20 μm.

19. The multilayer ceramic capacitor of claim 14, wherein the plurality of side margin portions respectively further includes a protrusion protruding toward the plurality of first internal electrodes and the plurality of second internal electrodes in the third direction and overlapping the plurality of dielectric layers in the first direction, and
a length of the edge portion in the third direction is greater than a protrusion length of the protrusion.

20. The multilayer ceramic capacitor of claim 14, wherein the first and second external electrodes are respectively disposed so as not to overlap the capacitance formation region in the third direction.
